(19) United States
(12) Patent Application Publication
(10) Pub. No.: US 2026/0139655 A1
(43) Pub. Date: May 21, 2026

(54) BI-DIRECTIONAL WAVE ENERGY CONVERTER

(71) Applicant: FELICIANNE AS, Oslo (NO)

(72) Inventor: Jørgen HØGMOE, Oslo (NO)

(73) Assignee: FELICIANNE AS, Oslo (NO)

(21) Appl. No.: 19/122,425

(22) PCT Filed: Oct. 20, 2023
(86) PCT No.: PCT/NO2023/060078

§ 371 Date: Apr. 18, 2025

(30) Foreign Application Priority Data
Oct. 20, 2022 (NO) 20221130

(51) Int. Cl. F03B 13/22; F03B 3/14; F03B 13/10; H02K 7/18

(52) U.S. Cl. CPC F03B 13/22; F03B 3/14; F03B 13/10; H02K 7/183; F05B 2220/706

(57) ABSTRACT

A bi-directional turbine device for generating electrical energy from wave movements, the turbine device being adapted to be arranged below the water line, wherein the bi-directional turbine device includes; a first shaft element with a second end section being connected to a platform for suspending the bi-directional turbine device, a first hub unit axially inserted on a first end section of the first shaft element, a first flange and a second flange fixed to the first end section at a predetermined distance from each other for limiting axial movement of the first hub unit along the first shaft element, a first shell element enclosing the first hub unit and the flanges for axially moving the first hub unit due to downward or upward water flow impacting the first shell element, a first plurality of blades encircling the first shell element and inserted to the first hub unit for providing torque to a first end section of the first shaft, wherein a base of each blade of the first plurality of blades is inserted through the first shell element and into the first hub unit, a pitch angle change assembly connecting at least one of the flanges and the first plurality of blades, wherein the pitch angle change assembly provide predetermined pitch angles of the first plurality of blades from the axial movement of the first hub unit.

### PRIOR FILED APPLICATION

The present application is a National Entry of PCT Application No. PCT/NO2023/060078, filed on Oct. 20, 2023, which claims priority to Norwegian Application No. NO 20221130, filed on Oct. 20, 2022. The entire contents of such prior applications are incorporated by reference herein.

### TECHNICAL FIELD

The present invention relates to a device and an arrangement for generating electrical energy from movements of the ocean, such as waves and current.

### BACKGROUND ART

Harnessing the energy of the ocean, or more specifically with devices that converts the energy of waves and currents into electricity are known as Wave Energy Converts or WEC's.

There are several types of WEC designs which more or less manage to efficiently convert wave energy into electricity. One of the more common designs of WECs is to harness ocean energy from the oscillation of waves, wherein as a wave move towards a direction, an area or spot of that wave moves in a vertical direction, i.e. in an up and down motion. The body of water in that spot moving in a vertical direction can be considered as a column of water.

There are several prior art of WEC's that can utilize the oscillation of waves, such as EP2425124B1 which describes a submerged turbine with at least a set of a plurality blades for harnessing the flow of water within the turbine in two directions, or bi-directional manner, in a column of water, wherein said blades can also swivel at their base and change their pitch angles in a passive manner for efficiently transforming the flow of water into torque in the turbine.

Other prior art, such as US2019257281A1 and JP2013189969A, describes WECs with bi-directional turbines, wherein they can receive a column of water that is converged towards their turbines. However, EP2425124B1 differs from the present invention in that the axles of the turbine are in the transverse direction relative to received column of water, nor have the same capabilities to change the pitch angles of their turbines.

Arguably, EP2425124B1 appears to have a relative complex design with many components, wherein its blades can also be subdivided into individual segments upon itself.

It is coveted to provide a WEC design that can effectively generate electrical energy from oscillating waves and efficiently utilize the components of a turbine for generating said electrical energy.

### SUMMARY OF INVENTION

It is an object of the present invention to provide a bi-directional flow turbine device that can generate electrical energy in a body of water.

It is further an object of the present invention to provide a bi-directional turbine device for generating electrical energy from wave movements, the turbine device being adapted to be arranged below the water line, wherein the bi-directional turbine device includes; a first shaft element with a second end section being connected to a platform for suspending the bi-directional turbine device, a first hub unit axially inserted on a first end section of the first shaft element, a first flange and a second flange fixed to the first end section at a predetermined distance from each other for limiting axial movement of the first hub unit along the first shaft element, a first shell element enclosing the first hub unit and the flanges for axially moving the first hub unit due to downward or upward water flow impacting the first shell element, a first plurality of blades encircling the first shell element and inserted to the first hub unit for providing torque to a first end section of the first shaft, wherein a base of each blade of the first plurality of blades is inserted through the first shell element and into the first hub unit, a pitch angle change assembly connecting at least one of the flanges and the first plurality of blades, wherein the pitch angle change assembly provide predetermined pitch angles of the first plurality of blades from the axial movement of the first hub unit.

Preferably, the second end section of the first shaft element is connected to a first electrical energy generator on the platform.

Preferably, the first end section of the first shaft element includes a rod element fixed to the first shaft element, wherein the rod element is surrounded by a cylinder device rotating about the rod element, wherein the second end section of the first shaft element is connected to a top part of a frame of the platform.

Preferably, the rod element is a stationary part and the cylinder device is a rotating part), wherein the stationary part and the rotating part together form a second electrical energy generator.

Preferably, the bi-directional turbine device further includes; a second shaft element with a second end section being connected to the platform for holding the bi-directional turbine device, a second hub unit axially inserted on a first end section of the second shaft element, a first flange and a second flange fixed to the first end section at a predetermined distance from each other for limiting axial movement of the second hub unit along the second shaft element, a second shell element enclosing the second hub unit and the flanges for axially moving the second hub unit due to downward or upward water flow impacting the first and second shell element, wherein the second shell element is adjacent to the first shell element at their widest opening and axially moves accordingly in the same axial direction with the first shell element, a second plurality of blades encircling the second shell element and inserted to the second hub unit for providing torque to a first end section of the second shaft, wherein a base of each blade of the second plurality of blades are inserted through the second shell element and into the second hub unit, wherein the second plurality of blades are adjacently below the first plurality of blades, a pitch angle change assembly connecting at least one of the flanges and the second plurality of blades, wherein the pitch angle change assembly provide predetermined pitch angles of the second plurality of blades from the axial movement of the second hub unit, wherein the pitch angle of the second plurality of blades is adapted to have a first pitch angle and the pitch angle of the first plurality of blades is adapted to have a second pitch angle, wherein the pitch angle of the second plurality of blades is adapted to have second pitch angle and the pitch angle of the first plurality of blades is adapted to have first pitch angle.

Preferably, the second shaft is located within the first shaft element, the second shaft is connected to the first electrical energy generator on the platform by a differential unit, wherein the differential unit further transfers torque from the second shaft to the first electrical energy generator.

Preferably, the second end section of the second shaft element is connected to a bottom part of a frame of the platform, wherein a stationary part of the first shaft element and a stationary part the second shaft element is a single connecting stationary part, wherein the single connecting stationary part is surrounded by two rotating parts rotating about the single connecting stationary part, wherein each of the two rotating parts rotating about the single connecting stationary part form a second electrical energy generator.

Preferably, the pitch angle change assembly is a first pitch angle change assembly, wherein each blade of the first plurality of blades includes a protrusion at the base of each blade, wherein the protrusion is connected to a lever item and the lever item is connected to a protrusion of a plurality of protrusions of a flange circumferentially located on the flange facing the hub unit.

Preferably, the pitch angle change assembly is a second pitch angle change assembly, wherein the base of each blade of the first plurality of blades includes a gear which interact with an elongated protrusion with linear gears, wherein the elongated protrusion extends from a flange.

It is further an object of the present invention to provide a bi-directional turbine device for generating electrical energy from wave movements, the turbine device being adapted to be arranged below the water line, wherein the bi-directional turbine device includes; a first shaft element with a second end section being connected to a platform for suspending the bi-directional turbine device, a first hub unit axially inserted on a first end section of the first shaft element, wherein the first hub unit includes a gear for engaging the first end section, a second hub unit axially inserted on a first end section of the first shaft element, wherein the second hub unit includes a gear for engaging the first end section, the first end section further includes a first gear located at the extreme end of the first end section and a second gear located at a predetermined distance of the extreme end of the first end section, wherein the first gear engages with the gear of the second hub unit and providing torque from the second hub unit on the first end section and forming the first gear set, wherein the second gear engages with the gear of the first hub unit and providing torque from the first hub unit on the first end section and forming the second gear set, a first shell element enclosing the first hub unit for axially moving both the first hub unit and the second hub unit and activating the second gear set at downward water flow impacting the first shell element, a second shell element enclosing the second hub unit for axially moving both the first hub unit and the second hub unit and activating the first gear set at upward water flow impacting the second shell element, wherein the second shell element is adjacent to the first shell element at their widest opening and axially moves accordingly with the first shell element, a first plurality of blades encircling the first shell element and inserted to the first hub unit for providing torque to a first end section by the second gear set, wherein a base of each blade of the first plurality of blades are inserted through the first shell element and into the first hub unit, wherein each of the blades the first plurality of blades have a fixed first pitch angle, a second plurality of blades encircling the second shell element and inserted to the second hub unit for providing torque to a first end section by the first gear set, wherein a base of each blade of the second plurality of blades are inserted through the second shell element and into the second hub unit, wherein each of blades of the second plurality of blades have a fixed second pitch angle.

Preferably, the first end section includes a third electric energy generator comprising a second cylinder device, wherein the second cylinder device includes the first gear and second gear for engaging the gears of the first and second hub units, and a second rod in connection with at least a shaft element, wherein the second cylinder device rotates about the second rod, wherein the at least a shaft element is connected to a frame of a platform.

It is further an object of the present invention to provide a bi-directional turbine device for generating electrical energy from wave movements, the turbine device being adapted to be arranged below the water line, wherein in that the bi-directional turbine device includes; a first shaft element with a second end section being connected to the platform for suspending the bi-directional turbine device, a first plurality of blades encircling and is fixed to a first end section of the first shaft element for providing torque to a first end section, wherein each of the blades the first plurality of blades have a fixed first pitch angle.

Preferably, the second end section of the first shaft element is connected to a fourth electrical energy generator on the platform, wherein the fourth electrical energy generator receive torque in a clockwise or counterclockwise direction form the first shaft element.

Preferably, the bi-directional turbine device further includes a funneling unit encircling at least a shell element and a plurality of blades for receiving and converging a flow of water towards a plurality of blades from an open end of the funneling unit.

Preferably, the device further includes at least one support motor or a flywheel for providing a hub unit torque for at least one rotation at the change of a predetermined pitch angle of the first or second plurality of blades.

It is further an object of the present invention to provide an arrangement for generating electrical energy comprising; a floating platform, and a plurality of bi-directional turbine devices, wherein each of the plurality of bi-directional turbine devices are suspended from the platform by a first shaft element and the plurality of bi-directional turbine devices are positioned at predetermined depth below the water line.

Preferably, the platform further includes a plurality of first electrical energy generators on the platform, wherein each of the first electrical energy generators is suspending a bi-directional turbine device below the waterline with a first shaft element at a predetermined depth, wherein the bi-directional turbine device drives the first electrical energy generators with the first shaft element.

Preferably, the platform further includes a frame for suspending or holding at least a bi-directional turbine device, wherein the at least one bi-directional turbine device is connected to at least a top or a bottom by at least a shaft element of the bi-directional turbine device.

Preferably, the platform is moored to floor of a body water with taut mooring lines for keeping the platform at a predetermined depth.

Preferably, the platform further includes a one or more heave plates near the bottom of the platform for limiting heave and roll movements affecting the platform deriving from the waves.

Preferably, the platform further includes at least a ballast tank and a buoyancy tank for providing self-regulating ballasting, wherein the buoyancy tank includes at least two sub compartments vertically positioned on top of each other, wherein each of the sub compartments have at least an inlet on top of the sub compartment and an outlet at the bottom of the sub compartment, wherein the outlet of a top sub compartment is in communication with the inlet of the bottom sub compartment.

### BRIEF DESCRIPTION OF DRAWINGS

FIG. 1 illustrates a perspective view of an embodiment of the invention,

FIG. 2 and FIG. 2a illustrates a side views of an embodiment of the invention including a first pitch angle change assembly with a cross section of the first shell element,

FIG. 2b illustrates a side view of an embodiment of the invention including a first pitch angle change assembly without the first shell element

FIG. 3 and FIG. 3a illustrates a perspective view of an embodiment of the invention including a second pitch angle change assembly with a cross section of the first shell element,

FIG. 4 illustrates a perspective view of an embodiment of the invention including a cross section of a funneling unit,

FIG. 5 illustrates a detailed cross section view of an embodiment of the invention with a second electrical energy generator,

FIG. 6 illustrates an embodiment of a plurality of the invention with second electrical energy generators fastened on a floating platform and being submerged,

FIG. 7 illustrates an embodiment of a plurality of the invention with first electrical energy generators being above water and are connected to a floating platform,

FIG. 8 illustrates an arrangement of a moored floating platform comprising a plurality of the invention with first electrical energy generators,

FIG. 9 illustrates an arrangement of a moored floating platform comprising a plurality of the invention with second electrical energy generators.

FIG. 10 illustrates an embodiment of the invention with two sets of plurality of blades and a differential unit,

FIG. 11 illustrates an embodiment of the invention with two sets of plurality of blades connected to a frame of the platform,

FIG. 12 illustrates another embodiment of the invention with two sets of plurality of blades,

FIG. 13 illustrates another embodiment of the invention with two sets of plurality of blades connected to a frame of the platform,

FIG. 14 illustrates another embodiment of the invention with a generator and fixed angle blades,

FIG. 15 illustrates an embodiment of the invention with a generator and fixed angle blades on a platform with heave plates,

FIG. 16 illustrates an embodiment of the invention with fixed angle blades connected to a differential gear and electrical energy generator.

FIGS. 17 and 18 illustrates detailed side views of an embodiment of the third differential unit,

FIG. 19 illustrates an exploded view of the third differential unit.

### DETAILED DESCRIPTION OF THE INVENTION

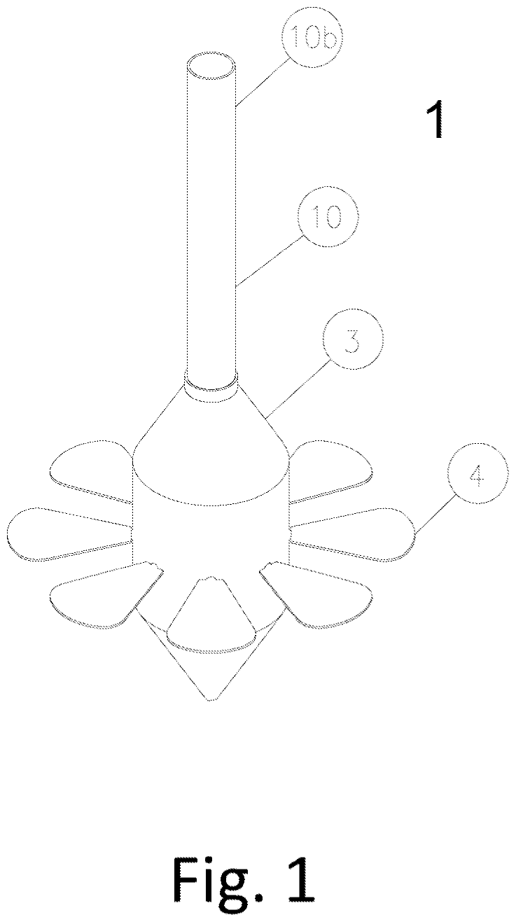

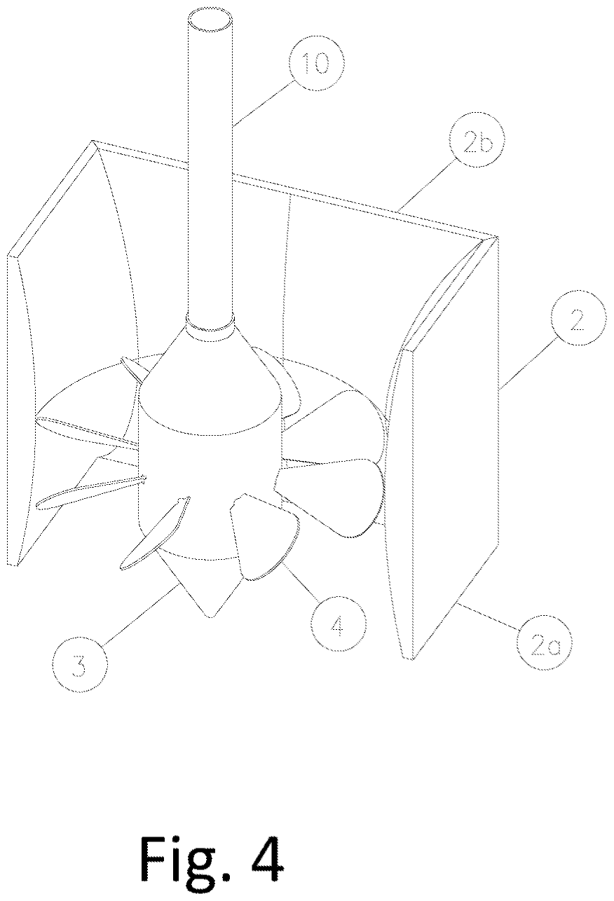

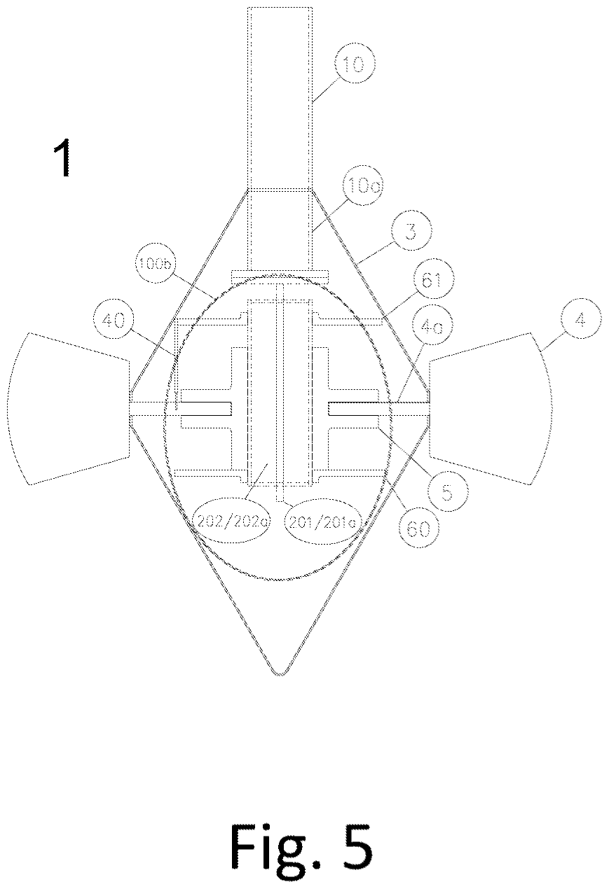

FIG. 1 to FIG. 3, FIG. 5, FIG. 10 to FIG. 14 shows an embodiment of the invention; a bi-directional turbine device 1 for generating electrical energy from receiving and transforming energy from a flow of water and a flow of water in the opposite direction, e.g. upwards and downwards flow in a body or a column of water due to wave motions.

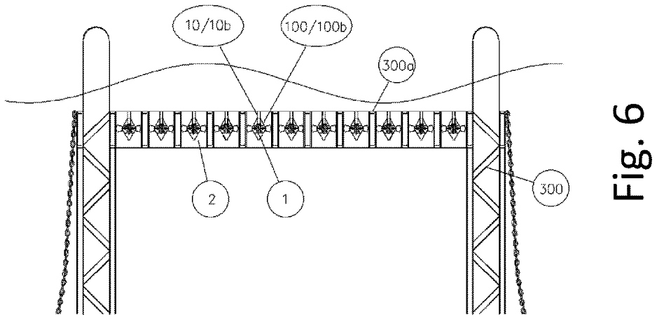

As shown in FIG. 6 to FIG. 9, the bi-directional turbine device 1 is connected to a first shaft 10 which in turn drives an electrical energy generator 100. The first shaft 10 can be solid rod or a hollow tube. The electrical energy generator 100 can be a first electrical energy generator 100a above the water line or a second electrical energy generator 100b below the water line. FIG. 6 to FIG. 9 also shows a plurality of bi-directional turbine devices 1 and said electrical energy generators 100 on a platform 300.

As shown in FIG. 1 to FIG. 2a and FIG. 3 to FIG. 5, the bi-directional turbine device 1 includes an oblong shaped first shell element 3 that surrounds an end section 10a of the first shaft 10, wherein the first shell element 3 have narrow pointed ends on each end and is wide in the midsection. The circumference of the first shell element's 3 midsection is surrounded by a first plurality of blades 4, which can swivel abouts their entry points on the first shell element 3. The shape of each blade of the first plurality of blades 4 can be, but is not limited to, a straight turbine blade or a propeller blade.

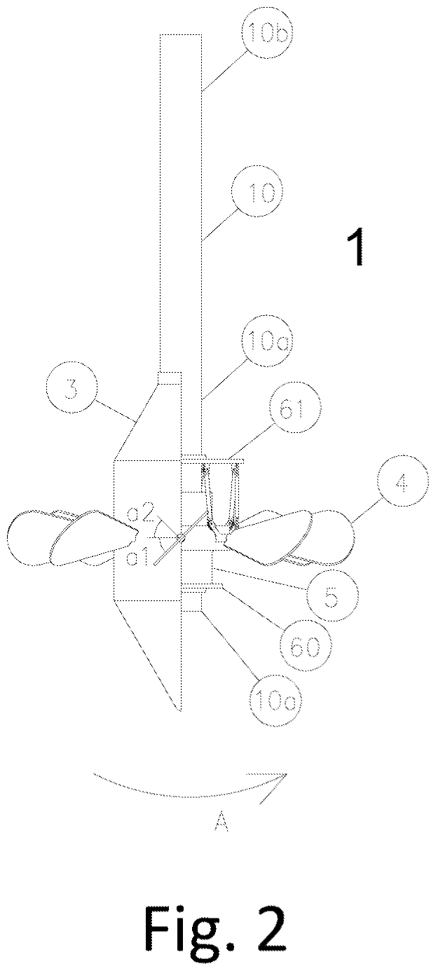

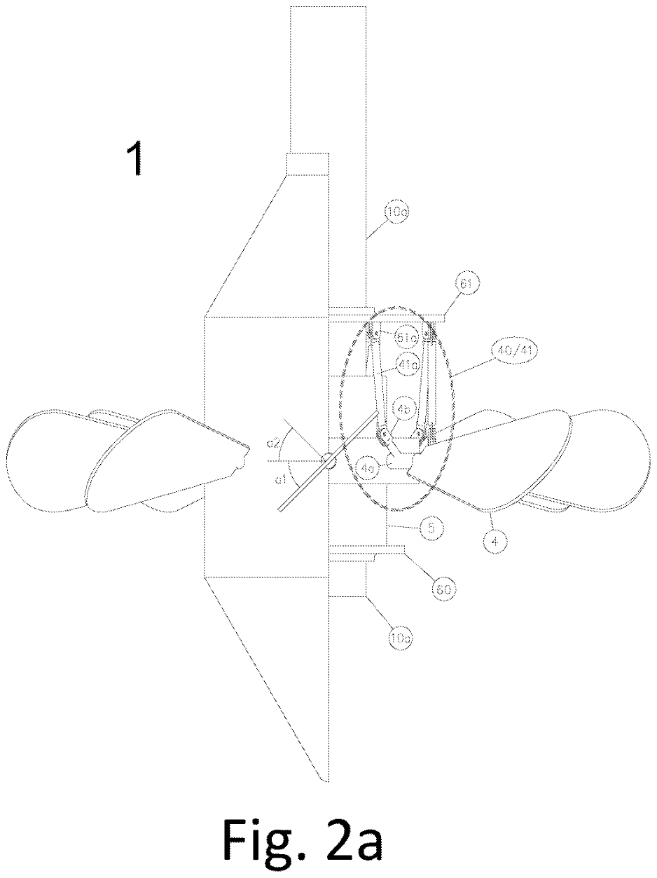

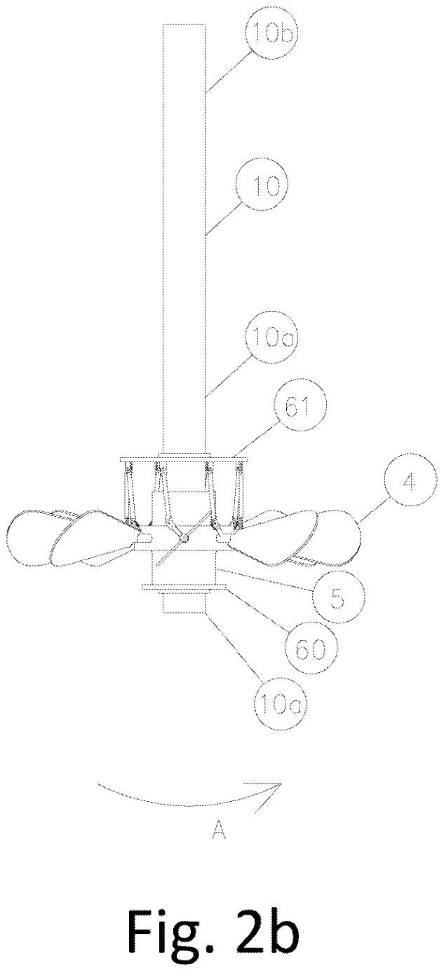

As shown in FIG. 2 and FIG. 2a, the first plurality of blades 4 have a first pitch angle a1 when receiving a flow of water in the longitudinal direction of the first shell element 3. Said first plurality of blades 4 can also change its pitch angle to a second pitch angle a2 for receiving a relative opposite flow of water in the longitudinal direction of the first shell element 3. In both first and second pitch angles a1, a2,the first plurality of blades 4 rotates about the first shaft 10 in a first direction A.

The change of pitch angles a1, a2 is managed by the movement of a first hub unit 5 along the longitudinal direction of the end section 10a, wherein each of the blades of the first plurality of blades 4 have a base 4a that connects to the first hub unit 5 through the first shell element 3. Wherein each base 4a of the first plurality of blades 4 can rotate about its connection to first hub unit 5 and the first shell element 3.

Adjacently below and above the first hub unit 5 is a first flange 60 and a second flange 61, wherein said flanges 60, 61 are fixed to and threaded on the end section 10a. The first 60 and second flange 61 are also spaced apart, wherein there is a predetermined allowance of space between the first 60 and second flange 61, permitting the first hub unit 5 a limited bi-directional movement along the longitudinal direction of the end section 10a in between the first 60 and second flange 61.

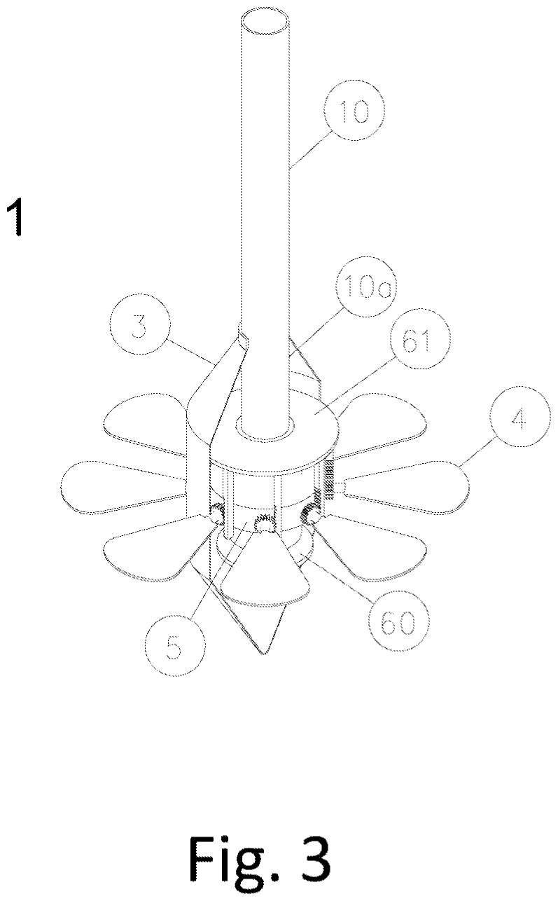

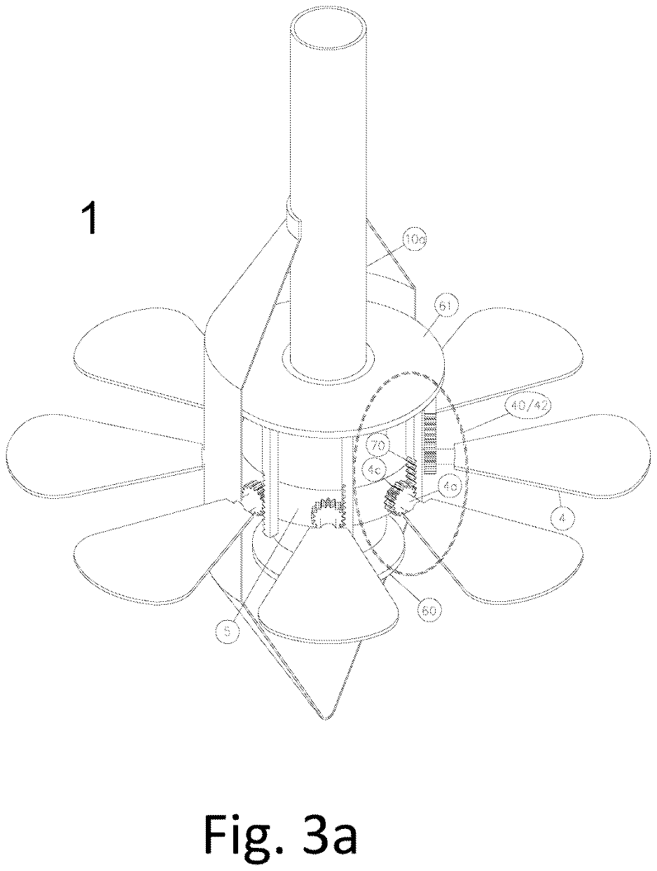

The bi-directional movement of the first hub unit 5, together with a pitch angle change assembly 40, as shown in FIGS. 2-3, manipulates the pitch angle of the first plurality of blades 4, either from the first pitch angle a1 to the second pitch angle a2, or from the second pitch angle a2 to the first pitch angle a1.

The pitch angle change assembly 40, can be a first pitch angle change assembly 41 (see FIG. 2, FIG. 2a-2b) or a second pitch angle change assembly 42 (see FIG. 3 and FIG. 3a).

With the first pitch change assembly 41, as shown in FIG. 2 and FIG. 2a-2b, the manipulation of the pitch angles a1, a2 of the first plurality of blades 4 includes a first pitch angle change assembly 41, which includes a protrusion 4b at the base 4a of each blade of the first plurality of blades 4. Said protrusion 4b is linked to a lever 41a, wherein said lever item 41a is also interconnectedly linked to a protrusion 61a of the second flange 61, wherein there are a plurality of protrusions 61a circumferentially located underneath the second flange 61. Alternatively, said protrusion 4b and lever 41a can alternatively be connected to another protrusion 60a (not shown) on the bottom of the first flange 60 (not shown) or connected to a protrusions 60a and 61a at the same time.

When the bottom edge of the first hub unit 5 is in contact with the side of the first flange 60 facing first hub unit 5, the pitch angle of the first plurality of blades 4 is at the first pitch angle a1, due to the connection between protrusions 4b, 61a and lever 41a. This occurs when a water flows downward on the first shell element 3 and the plurality of the blades 4, which in turn pushes down the first hub unit 5 and provides the first pitch angle a1.

And when the top edge of the first hub unit 5 is in contact with the side of the second flange 61 facing the first hub unit 5, the pitch angle of the first plurality of blades 4 is at the second pitch angle a2. This occurs when water flows upwards on the first shell element 3 and the plurality of the blades 4, which in turn pushes up the first hub unit 5 along the first end section 10a and provides the second pitch angle a2.

As shown in FIG. 3 and FIG. 3a, an alternative manipulation of the pitch angles a1, a2 of the first plurality of blades 4 can be done with the second pitch angle change assembly 42, which is a rack and pinion embodiment, wherein each blade of the first plurality of blades 4 further includes a gear 4c at the base 4a of each blade 4, acting as the pinion. Whereas an elongated protrusion with linear gears or racks 70, acting as the rack, extends from first flange 60 towards the second flange 61, or vice versa, extending partially or completely between the flanges 60, 61.

Thus, first pitch angle a1 is achieved for the first plurality of blades 4 when gear 4c move downwards, due to downward flow of water on the first shell element 3, on the elongated protrusion with racks 70 towards the first flange 60, until the bottom edge of the first hub unit 5 is in contact with the side of the first flange 60 facing towards the first hub unit 5. To achieve the second pitch angle a2 for the first plurality of blades 4 the gear 4c moves upwards, due to upward flow of water on the first shell element 3, on the elongated protrusion with racks 70 towards the second flange 61, until the top edge of the first hub unit 5 is in contact with the side of the first flange 60 facing towards the first hub unit 5.

What primarily dictates the pitch angles a1, a2 of the first plurality of blades 4 is the direction of the water flow impacts the first shell element 3, deriving from the waves and/or currents.

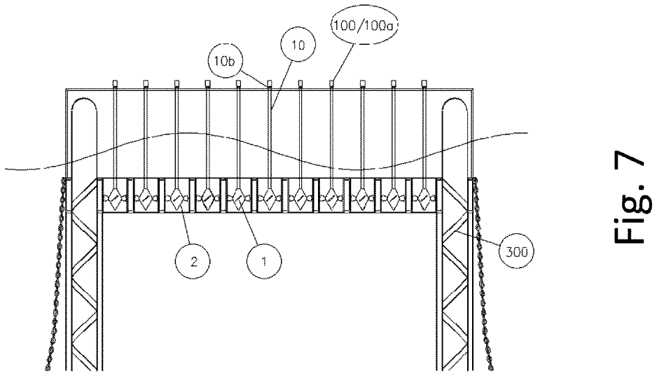

As shown in FIG. 7 a second end section 10b of the first shaft 10 is connected to a first electrical energy generator 100a located above the water line. In this configuration, the first hub unit 5 is also inserted on the first shaft 10 and can relatively freely move in the longitudinal direction of the first shaft 10, only limited by the flanges 60, 61, a first or second pitch angle change assembly 41, 42 and the first plurality of blades 4. The first hub unit 5 and the first shaft 10 will rotate in the same direction due to being in connection with the flanges 60, 61 and the first or second pitch angle change assembly 41, 42. Therefore, as the first plurality of blades 4 rotates about the first shaft 10 due to the water flow, torque is provided to the first shaft 10 from the first hub unit 5 which in turn drives the first electrical energy generator 100a.

As shown in FIG. 5 and FIG. 6, embodiment of the bi-directional turbine device 1 with the second electrical energy generator 100b. A plurality of bi-directional turbine device 1 are placed in a frame 300a of the platform 300. In this embodiment the primary function of the first shaft 10 is to hold and suspend the bi-directional turbine device 1 and preferably the first shaft 10 should not rotate. The first shaft 10 itself is connected to the top part of the frame 300a. The second electrical energy generator 100b includes a rod element 201 and cylinder device 202 wherein the rod element 201 replaces the first end section 10a of the first shaft 10. And the cylinder device 202 can freely rotate about the rod element 201, wherein the rod element 201 is a stationary part 201a of the second electrical energy generator 100b and the cylinder device 202 is a rotating part 202a of the second electrical energy generator 100b, wherein the stationary part 201a and rotating part 202a generate electrical energy. In this configuration the first 60 and second flange 61 are inserted and fixed to the rotating part 202a, and the first hub unit 5 is also inserted on the rotating part 202a. The motion of the first hub unit 5 is limited by the flanges 60, 61, a first or second pitch angle change assembly 41, 42 and the first plurality of blades 4. As the first plurality of blades 4 rotates driven by the water flow, torque is provided to the rotating part 202a which in turn drives the second electrical energy generator 100b.

As shown in FIG. 6, which shows a plurality of submerged bi-directional turbine devices 1 with a plurality of second electrical energy generators 100b. The plurality of submerged bi-directional turbine device 1 are fixed to a frame 300a, which in turn is fixed the submersible part of a platform 300, such as the buoyant columns or pontoons of the platform 300. The waves and ocean currents flow or oscillate through the array of devices 1. Optionally, in an embodiment said frame 300a with a plurality of submerged bi-directional turbine devices 1 can be fastened to a fixed installation (not shown) in a body of water, wherein the fixed installation, such as a jacket platform, is fastened to the bottom of the body water.

And as the first shell element 3 receives an upwards flow of water, towards the platform 300, in the longitudinal direction relative to the first shell element 3, the first shell element 3 is moved slightly upwards. Correspondingly, the first plurality of blades 4 are also moved slightly upwards together with the first shell element 3 in the same direction, until the first hub unit 5 is limited by the second flange 61, and simultaneously the first plurality of blades 4 also change their pitch angle and swivel to the second pitch angle a2 due to the interconnected protrusions 4b, 61a and levers 41a of the first pitch angle change assembly 41, or gear 4c and rack 70 of the second pitch angle change assembly 42. And with the second pitch angle a2, the first plurality of blades 4 when receiving the upwards flow of water will rotate in a first direction A and provide torque which will in turn provide torque to the first shaft 10. The torque provided rotates the first shaft 10 also in the first direction A, and consequently driving the electrical energy generator 100.

In the case of downward flow affecting the first shell element 3, i.e. as in towards to the bottom in a body of water, as the first shell element is moved slightly downwards along the first shaft 10, through the mentioned interconnections by the first plurality of blades 4, the first hub unit 5 is also moved down towards the first flange 60, and the pitch angle of the first plurality of blades 4 swivels from the second pitch angle a2 to the first pitch angle a1. The first plurality of blades 4 will also rotate in the first direction A due to the downward flow and having the pitch angle at first pitch angle a1, providing torque to the first shaft 10 Thus rotating the first shaft 10 also in the first direction A when the pitch angle is the first pitch angle a1, and consequently driving the electrical energy generator 100.

And just as the pitch angle change from the first pitch angle a1 to the second pitch angle a2, or from the second pitch angle a2 to the first pitch angle a1, due to the change of flow direction on the first plurality of blades 4, a support motor (not shown) can also be included in the device 1 for assisting the first plurality of blades 4 to do at least one rotation after change of pitch angle.

In another embodiment, as an alternative to the support motor (not shown), a flywheel (not shown) is included to the bi-directional turbine device 1 or located near the top end 10b of the axle will assist the first plurality of blades 4 to do at least one rotation in the first direction A as the first hub unit 5 moves up or down along the first shaft 10 due to the changed direction of water flow.

As shown in FIG. 4, the bi-directional turbine device 1 can further include a funneling unit 2 surrounding the first shell element 3 and the first plurality of blades 4. The funneling unit 2 have large openings at each end for receiving a flow of water at one open end 2a or the other open end 2b of the funneling unit 2. The funneling unit 2 is shaped and sized in a manner where the funneling unit 2 converge any received flow of water towards the first plurality of blades 4 at a predetermined water flow speed. The funneling unit 2 have a predetermined form and predetermined size of each opening 2a, 2b for managing the speed of the flow of water converging towards the first plurality of blades 4. Said predetermined form and predetermined size of the funneling unit 2 and its openings 2a, 2b can be adapted to local environmental conditions for providing an optimized water flow speed on the first plurality of blades 4.

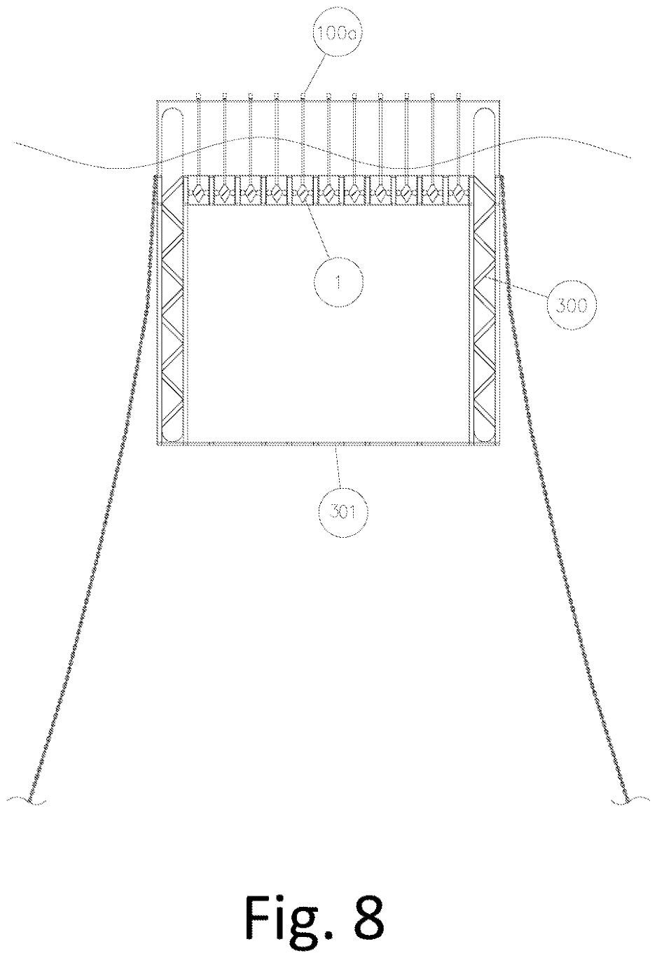

FIG. 8 shows an embodiment of an arrangement for generating electrical energy with bi-directional turbine devices 1 with first electrical energy generators 100a, installed on a floating semi-submersible platform 300 which is moored to the floor of a body of water, such as the ocean floor. The semi-submersible platform 300 can be positioned offshore where the ocean conditions are favorable for generating electrical energy or in other suitable locations and equipped with the bi-directional turbine devices 1.

The platform 300 can be kept in said position by being moored to the floor of the body of water, such as oceans or lakes, with mooring lines for maintaining said position and operating depth of the platform, the depth below the waterline bi-directional turbine devices 1 can generate energy from the waves and currents. Said mooring lines are taut for maintaining said position and operating depth. Alternatively, dynamic position thrusters (not shown) can be included to the platform 300 for maintaining said position.

The plurality of bi-directional turbine devices 1 are submerged by the platform 300 at a predetermined depth beneath the water line for generating energy. The first electrical energy generators 100a are positioned on an elevated deck of the platform 300 above the water line, wherein torque is provided to the first electrical energy generators 100a from the bi-directional turbine devices 1 by the first shaft element 10.

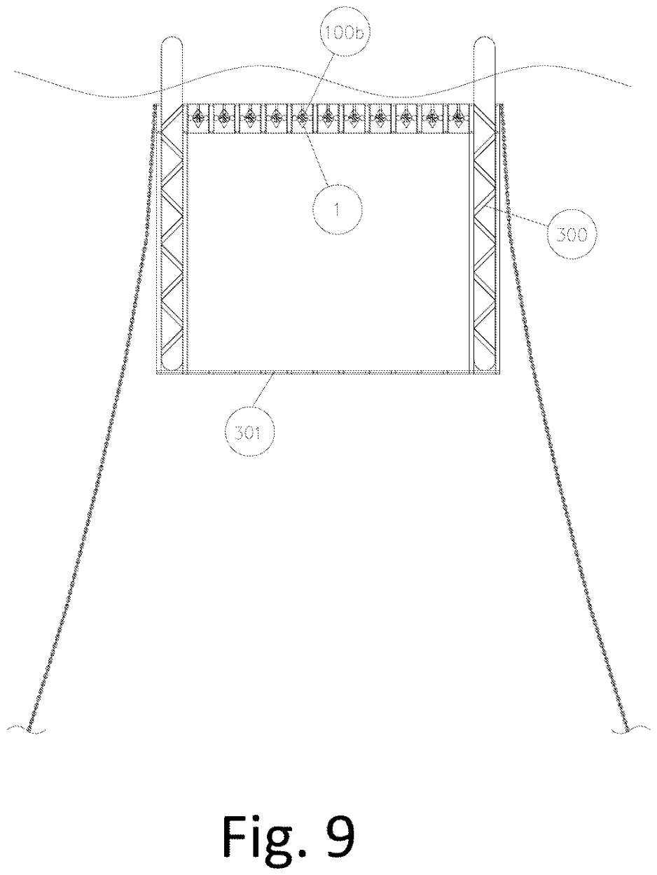

FIG. 9 shows another embodiment of an arrangement with a semi-submersible platform 300 moored to the ocean floor, including a plurality of bi-directional turbine devices 1 with embedded second electrical energy generators 100b. As in the previously mentioned embodiment, the plurality bi-directional turbine devices 1 are submerged by the platform 300 at a predetermined depth beneath the water line for generating energy from the flow of water.

The primary function of the first shaft 10 is to hold and suspend the bi-directional turbine device 1 and preferably the first shaft 10 should not rotate. The first shaft 10 itself, or more specifically its second end section 10b, is connected to the top part of the frame 300a. As shown in FIG. 5, the second electrical energy generator 100b includes a rod element 201 and cylinder device 202 wherein the rod element 201 replaces the first end section 10a of the first shaft 10. And the cylinder device 202 can freely rotate about the rod element 201, wherein the rod element 201 is a stationary part 201a of the second electrical energy generator 100b and the cylinder device 202 is a rotating part 202a of the second electrical energy generator 100b, wherein the stationary part 201a and rotating part 202a generate electrical energy. In this configuration the first 60 and second flange 61 are inserted and fixed to the rotating part 202a, and the first hub unit 5 is also inserted on the rotating part 202a. The motion of the first hub unit 5 is limited by the flanges 60, 61, a first or second pitch angle change assembly 41, 42 and the first plurality of blades 4. As the first plurality of blades 4 rotates driven by the water flow, torque is provided to the rotating part 202a which in turn drives the second electrical energy generator 100b.

FIG. 10 shows another embodiment of the bi-directional turbine device 1 coupled to a first electrical energy generator 100a located above the water line. This embodiment includes a second plurality of blades 4′ adjacently below the first plurality of blades 4, wherein the second plurality of blades 4′ also have a corresponding second shell element 3′, a second hub unit 5′, a pitch change assembly 40, a first 60 flange and a second flange 61. The second plurality of blades 4′ encircles the second shell element 3′ and each of the blades of the second plurality of blades 4′ have a base 4a′ that connects to the second hub unit 5′ through the second shell element 3′.

The first shell element 3 and the second shell element 3′ act as cones for receiving water flow at their pointy ends, and that the shell element 3, 3′ are positioned in a manner wherein they are adjacent to each other at their wide open end.

Said embodiment shown in FIG. 10 further illustrates that the first hub unit 5 is connected to the first shaft 10 and the second hub unit 5′ is connected to a second shaft 10′, wherein the first shaft 10 is preferably a hollow tube and the second shaft 10′ is located within and passes through the first shaft 10. The first 10 and second shaft 10′ is coupled to the first electrical energy generator 100a by a differential unit 80, transferring the torque from the first 10 and second shaft 10′ to the first electrical energy generator 100a.

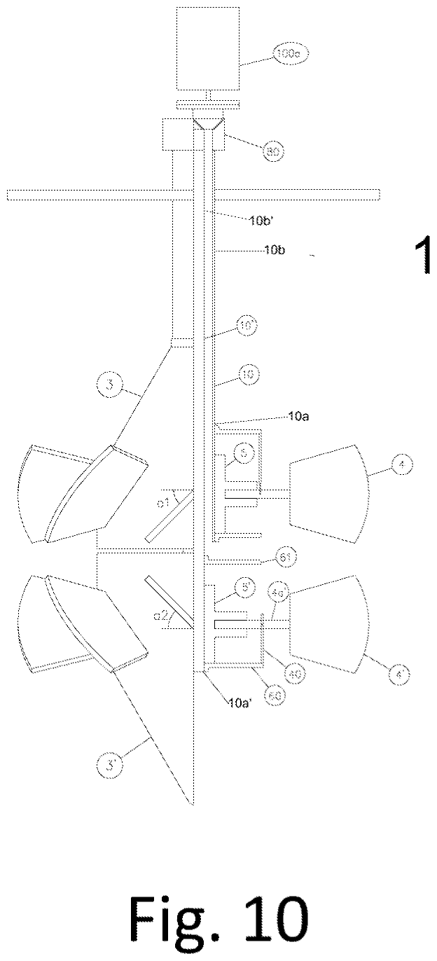

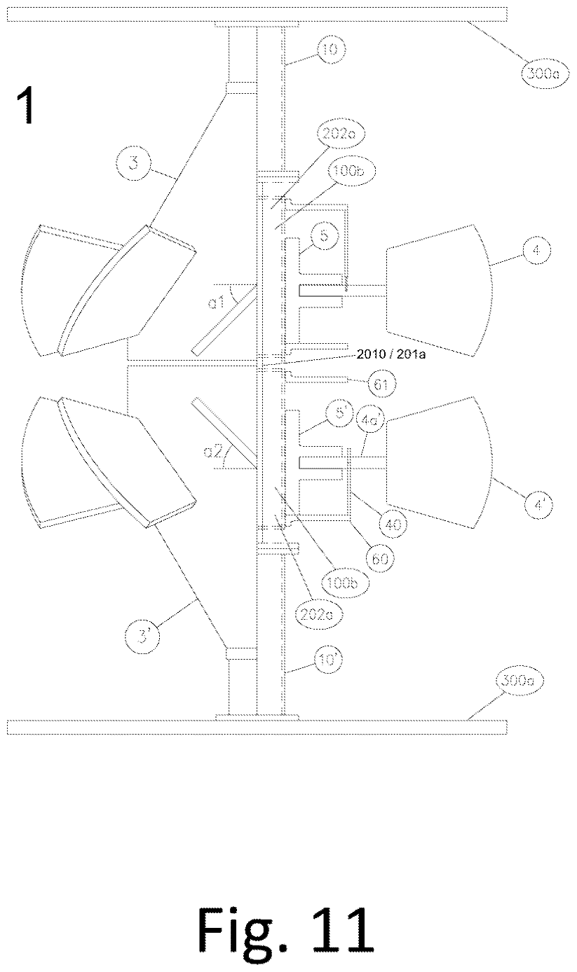

FIG. 11 shows another embodiment of the bi-directional turbine device 1 coupled to two second electrical energy generators 100b, a second electrical generator 100b of the first shaft element 10 and a second electrical generator 100b of the second shaft element 10′, wherein the bi-directional turbine device 1 is located below the water line. Each of the second electrical energy generators 100b comprise of a rod element 201 and cylinder device 202, otherwise known as a stationary part 201a and rotating part 202a. This embodiment also includes a second plurality of blades 4′ adjacently below the first plurality of blades 4, wherein the second plurality of blades 4′ also have a corresponding a second shell element 3′, a second hub unit 5′, a pitch change assembly 40, a first 60 flange and a second flange 61. The second plurality of blades 4′ also encircles the second shell element 3′ and each of the blades of the second plurality of blades 4′ have a base 4a′ that connects to the second hub unit 5′ through the second shell element 3′.

Said embodiment shown in FIG. 11 further illustrates that the first hub unit 5 is inserted on the rotating part 202a of the first shaft element 10 and the second hub unit 5′ inserted on the rotating part 202a of the second shaft element 10′, wherein the first shaft 10 is connected to the top part of the frame 300a and the second shaft 10′ is connected to the bottom part of the frame 300a. Each of the stationary part 201a of the two second electrical generators 100b together form a connecting stationary part 2010 for connecting together the first shaft element 10 and the second shaft element 10′.

As shown in both FIG. 10 and FIG. 11, the embodiments with the first plurality of blades 4 and the second plurality blades 4′ illustrates that if the first plurality of blades 4 have the first pitch angle a1, the second plurality blades 4′ have second pitch angle a2 as the water flows in the longitudinal direction along the shafts 10, 10′. As the water flows in the opposite longitudinal direction, the first plurality of blades 4 would switch to the second pitch angle a2, the second plurality blades 4′ would switch to first pitch angle a1.

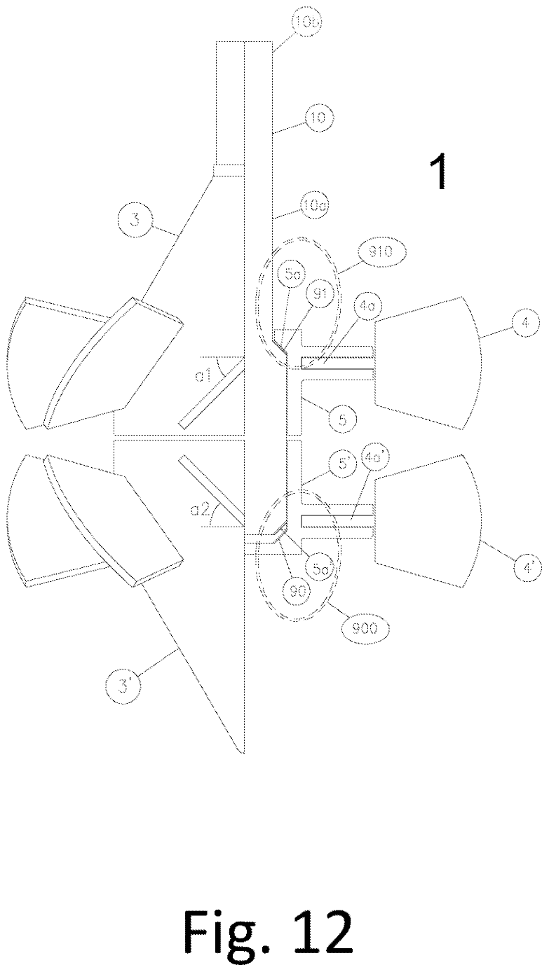

FIG. 12 shows another embodiment of the bi-directional turbine device 1 coupled to a first electrical energy generator 100a located above the water line. This embodiment also includes a first and second plurality of blades 4, 4′, wherein the first plurality of blades 4 have a first pitch angle a1 that is fixed and the second plurality of blades 4′ have a second pitch angle a1 that is also fixed. Here the first shaft 10 is connected to the first electrical energy generator 100a by the second end section 10b, and the first end section 10a includes a first gear 90 at the extreme end of the first end section 10a and a second gear 91 at a predetermined distance from the extreme end of the first end section 10a.

A first hub unit 5 and a second hub unit 5′ are inserted on the first end section 10a, wherein the first hub unit 5 includes a gear 5a for engaging with the second gear 91 of the first end section 10a, defined as the second gear set 910, and the second hub unit 5′ includes a gear 5a′ for engaging with the first gear 90 of the first end section 10a, defined as the first gear set 900, wherein either first gear set 900 or the second gear set 910 is utilized when the bi-directional turbine device 1 is in use. The hub units 5, 5′ is shaped in a manner that permits limited movement in the axial direction of the first shaft element 10, wherein the downward movement of the hub units 5, 5′ engage the second gear set 910 and the upward movement of the hub units 5, 5′ engage the first gear set 900. Said gear sets 900, 910 can be any type of gear sets.

As further shown in FIG. 12, a first shell element 3 is inserted on the first shaft element 10 for enclosing the first hub unit 5 and partially enclosing the first end section 10a, and mirroring the first shell element 3, a second shell element 3′ is inserted on the first shaft element 10 for enclosing the second hub unit 5′ and partially enclosing the first end section 10a.

The first plurality of blades 4 encircles the first shell element 3 and each of the blades of the first plurality of blades 4 have a base 4a that connects to the first hub unit 5 through the first shell element 3′. The second plurality of blades 4′ encircles the second shell element 3′ and each of the blades of the second plurality of blades 4′ have a base 4a′ that connects to the second hub unit 5′ through the second shell element 3′.

As in the embodiments shown in FIGS. 10 and 11, the first shell element 3 and the second shell element 3′ act as cones for receiving water flow at their pointy ends, at that the shell element 3, 3′ are adjacent to each other at their wide end.

The mechanics of this embodiment of the bi-directional turbine device 1 functions in a specific manner wherein as the water flows downward on the first shell element 3, the first shell element 3 pushes down on the first hub unit 5, due to the bases 4a of the first plurality of blades 4 connecting the first shell element 3 to the first hub unit 5. As the first hub unit 5 is pushed down, the second gear set 610 is engaged, wherein torque is provided on the first shaft element 10 from the rotating first plurality of blades 4 due to the downward waterflow.

And when the water flows upwards on the second shell element 3′, the second shell element 3′ pushes up on the second hub unit 5′, due to the bases 4a′ of the second plurality of blades 4′ connecting the second shell element 3′ to the second hub unit 5′. As the second hub unit 5 is pushed up, the first gear set 900 is engaged, wherein torque is provided on the first shaft element 10 from the rotating second plurality of blades 4′ due to the upward waterflow.

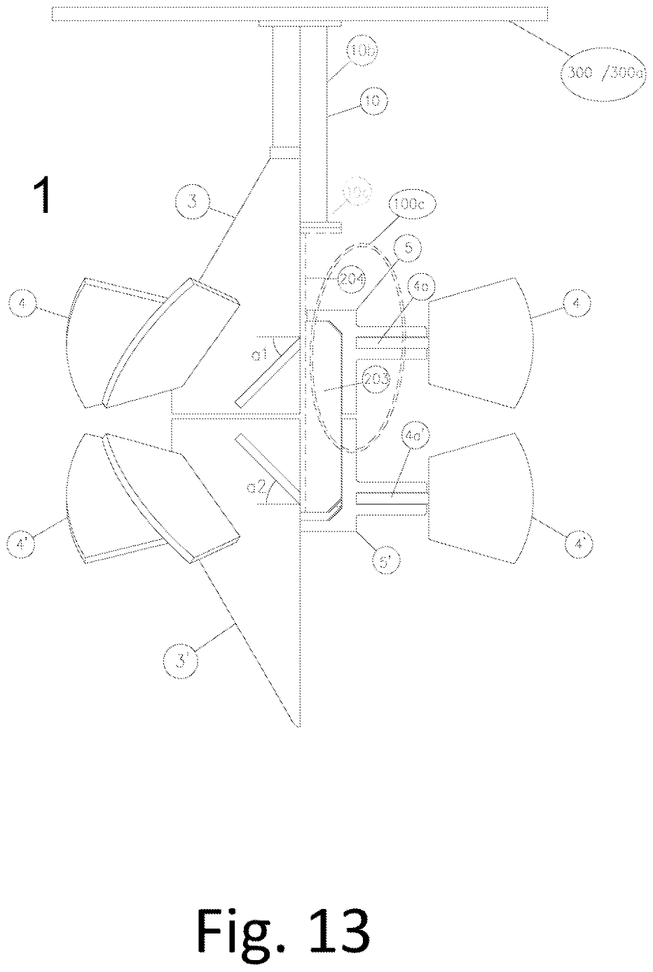

FIG. 13 shows another embodiment of the bi-directional turbine device 1 coupled to a third electrical energy generator 100c located below the water line, including a first plurality of blades 4 having a first pitch angle a1 that is fixed and a second plurality of blades 4′ having a second pitch angle a1 that is also fixed. In this embodiment the first end section 10a is replaced by the third electrical energy generator 100c. The third electrical energy generator 100c comprise of a second cylinder device 203 which includes the first gear 90 and second gear 91 of the previous first end section 10a for coupling with the gears of the hub units 5, 5′ for engaging the first and second gear sets 900, 910. The second cylinder device 203 rotates about a second rod 204 together forming the third electrical energy generator 100c. The second rod 204 is connected to the first shaft element 10 at its upper.

Alternatively (not shown), a second shaft element 10′ is connected at the lower end of the second rod 204, wherein the first shaft element 10 and the second shaft element 10′ is connected to the top and bottom part of the frame 300a of the platform 300.

The hub units 5, 5′ are mechanically connected to each other, wherein their vertical movement along the axis of the first shaft 10 is restricted. However, the said connection between the hub units 5, 5′ permits each of the hub units 5, 5′ to rotate about each other.

The hub units 5, 5′, shown in FIG. 12 and FIG. 13, are mechanically connected to each other (not shown), wherein their vertical movement along the axis of the first shaft 10 is restricted. However, the said mechanical connection between the hub units 5, 5′ permits each of the hub units 5, 5′ to rotate about each other, wherein said mechanical connection can include an arrangement which can include at least one bearing. Optionally, said mechanical connection can also include a second differential unit (not shown) which mechanically connects the hub units 5, 5′ together. The second differential unit can utilize the opposite rotational force of the plurality of blades 4, 4′ connected to a hub unit 5, 5′ whose gear set 900, 910 that is not engaged, wherein the second differential unit can provide said opposite rotational force to the to a hub unit 5, 5′ whose gear set 900, 910 that is engaged as an additional torque to the first shaft 10.

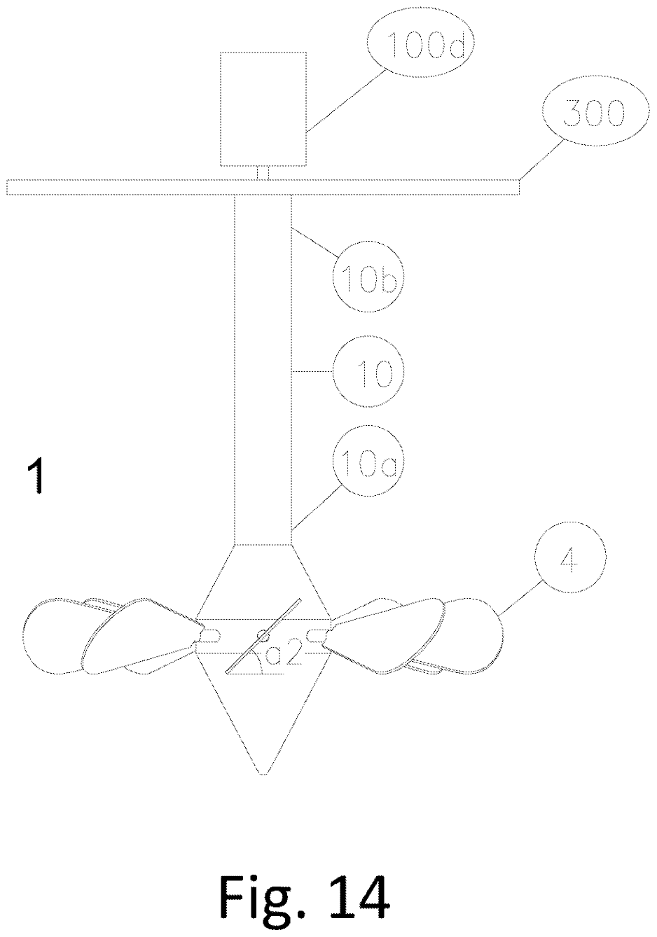

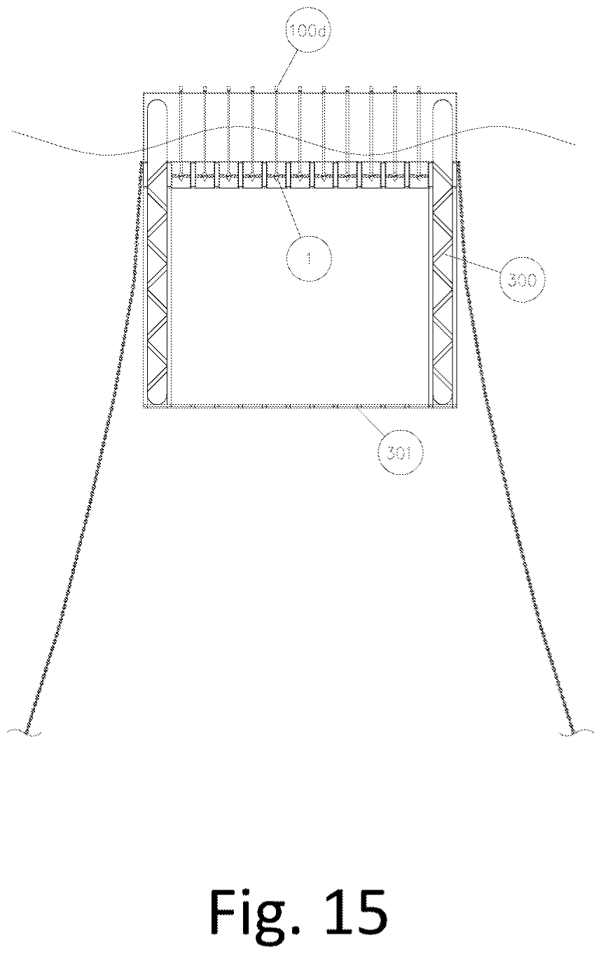

Alternatively, as shown in FIG. 14 and FIG. 15, an embodiment of the invention can include a bi-directional turbine device 1 connected to a fourth electrical energy generator 100d above the water line on a platform 300, including at least a first plurality of blades 4 having a first pitch angle a1 that is fixed or second pitch angle a2 that is fixed. In this embodiment this fourth electrical energy generator 100d can receive torque in a clockwise direction or a counter-clockwise direction and generate energy thereof, provided from a first shaft element 10, wherein the fourth electrical energy generator 100d is coupled to the first shaft element 10 at the second end section 10b of the first shaft element 10. At least the first plurality of blades 4 with a first pitch angle a1 or a second pitch angle a2 that is fixed surround and is connected to the first end section 10a of the first shaft element 10. Here, if at least one of this embodiment of bi-directional turbine device 1 is installed on the platform 300 with heave plates 301, a bi-directional turbine device 1 would also benefit greatly from the stability in water provided by heave plates 301. The heave plates 301 would assist in providing the upwards and downwards flow of water, deriving from the waves, towards the first plurality of blades 4, because without it the platform 300 would follow the upwards and downwards movement of the waves, lessening the flow of water affecting the bi-directional turbine device 1.

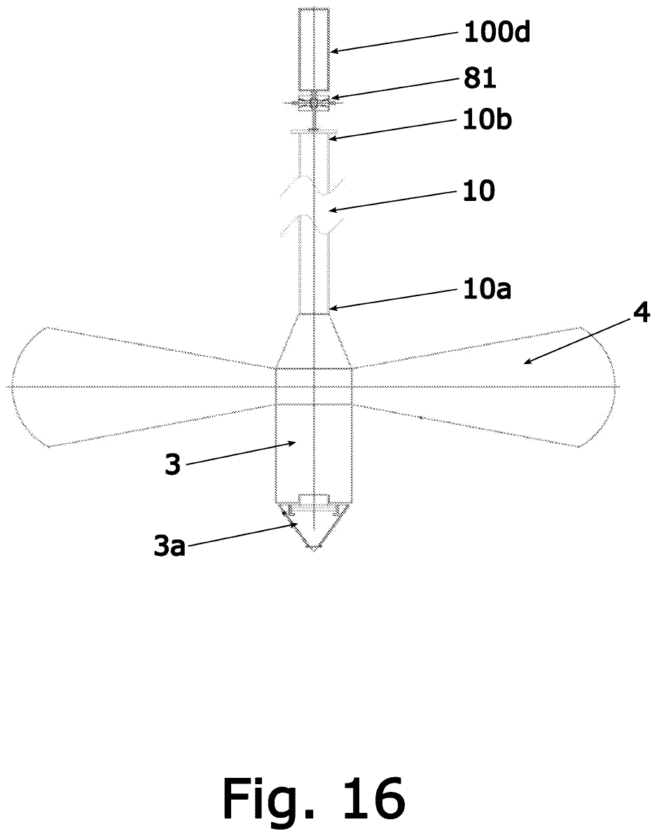

FIG. 16 shows another embodiment of a bi-directional turbine device 1 connected to a fourth electrical energy generator 100d above the water line on a platform 300, wherein the fourth electrical energy generator 100d also includes a third differential unit 81. On one end of the third differential unit 81, the third differential unit 81 provides torque to the fourth electrical energy generator 100d in one direction, either clockwise or counterclockwise. On the opposite end of the third differential unit 81, the third differential unit 81 can receive torque in a clockwise direction or a counterclockwise direction, said torque is provided from a first shaft element 10, wherein the second end section 10b of the first shaft element is connected to the third differential unit 81.

And as further shown in FIG. 16, a first shell element 3 surrounds the end section 10a of the first shaft 10, wherein the first shell element 3 have narrow pointed ends on each end and is wide in the midsection. The circumference of the first shell element's 3 midsection is surrounded by a first plurality of blades 4, wherein the first plurality of blades 4 having a first pitch angle a1 that is fixed or second pitch angle a2 that is fixed. The first shell element 3 can include an end part 3a that is fixed to a support structure (not shown) on the submersible platform 300. The end part 3a allows the first shell element 3 to rotate about the end 3a, but limits any vertical, longitudinal and transverse movements.

Alternatively, first plurality of blades 4 can be directly connected to and surround the first end section 10a of the first shaft 10. The first end section 10a can still include an end part 3a that is fixed to a support structure (not shown) on the submersible platform 300. The end part 3a allows the first end section 10a to rotate about the end part 3a, but limits any vertical, longitudinal and transverse movements.

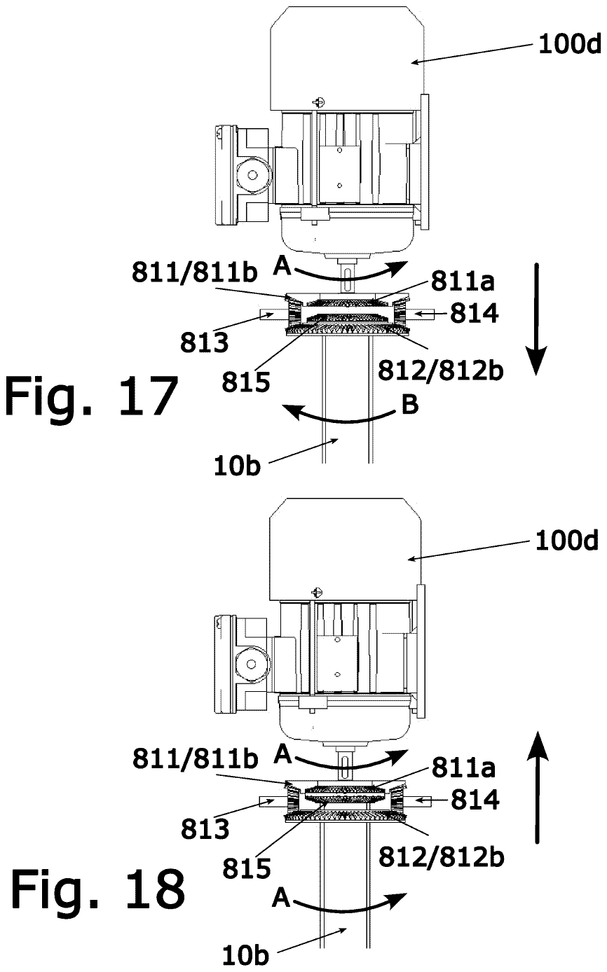

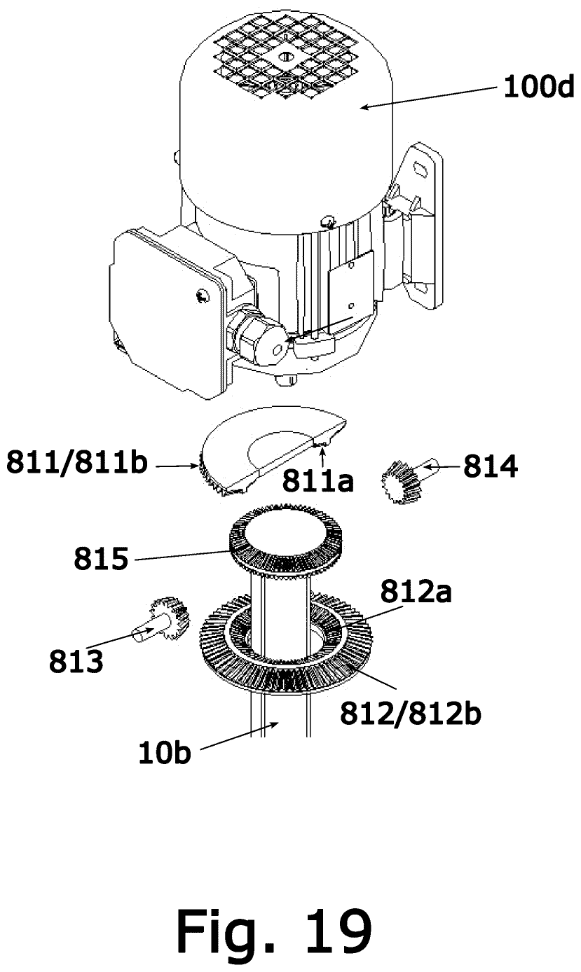

As shown in FIGS. 17-19 are detailed views of an embodiment of the third differential unit 81, wherein the third differential unit 81 comprise a first ring gear 811, wherein the first ring gear 811 is connected to a shaft of the fourth electrical energy generator 100d (FIGS. 17-19 illustrates an embodiment of the fourth electrical generator 100d). The third differential unit 81 further comprise of a second ring gear 812. Both first- and second ring gears 811, 812 includes gears in their inner edge 811a, 812a and gears in their outer edge 811b, 812b, wherein the teeth-sides of the first- and second ring gears 811, 812 are facing each other.

In between the first- and second ring gears 811, 812 are first-and second pinions 813, 814, wherein the first- and second pinions 813, 814 each are mated with the outer edges 811b, 812b of the first- and second ring gears 811, 812. In between the first- and second ring gears 811, 812 is a drive pinion 815 that is connected to the second end section 10b of the first shaft element 10. The drive pinion 815 is preferably disc-shaped with gears on each side for actuating with the inner edge gear 811a, 812a of the first-811 or second ring gear 812.

As shown in FIG. 18, as the water flows upwards towards the first shell element 3 and the plurality of blades 4, the drive pinion 815 moves upwards and is mated with the first ring gear 811 and provides rotation in the first direction A to the fourth electrical energy generator 100d. The rotation is provided from the plurality of blades 4 that have a fixed first pitch angle a1 or a second pitch angle a2.

However, as shown in FIG. 17, when the water flows downwards, the drive pinion 815 is mated with second ring gear 812 and the drive pinon 815 provides rotation, deriving from the plurality of blades 4 with a fixed pitch angle a1, a2, to the second ring gear 812 in the opposite direction, a second direction B. This will in turn rotate the first- and second pinions 813, 814, both of which would in turn rotate the first ring gear 811 in the first direction A.

In an embodiment of the submersible platform 300 has heave plates 301 (see FIG. 8, FIG. 9 and FIG. 15) which are large and substantially flat metal plates or similar structures. The heave plates 301 are preferably installed horizontally at the bottom of the submersible platform for inducing wave damping effect and provide hydrodynamic added mass for reducing platform movement from incoming waves affecting the platform 300. These heave plates 301 are provided to further reduce motions of the platform 300 and thereby ensure that the wave motions mostly are relative to the first plurality of blades 4 of the bi-directional turbine device 1 instead of moving the platform 300 itself. Preferably said wave currents converge towards the first plurality of blades 4 by means of the funneling unit 2.

Another embodiment of a submersible platform 300 with a plurality of bi-directional turbine devices 1, wherein the submersible platform 300 can include a ballasting system (not shown) within the submersible platform 300, preferably a self-regulating ballasting system within each structural elements of the platform 300, structural elements such as the columns and/or pontoons of a submersible platform 300.

Said self-regulating ballasting system can include at least one ballast tank (not shown) and at least one buoyancy tank (not shown), wherein the buoyancy tank includes at least two sub compartments, placed on top of one another, and each of the sub compartments have at least one inlet near the top of the sub compartment for allowing water access into the buoyancy tank in case of different water elevation relative to the submersible platform 300 depending on the wave height.

A sub compartment of a buoyancy tank receives water through at least one inlet, and the water rises within the sub compartment up to the receiving inlet, wherein the water level in the filled sub compartment of a buoyancy tank is higher than the surrounding still water level.

Each sub compartment of a ballast tank has at least one outlet near the bottom of the sub compartment for allowing water out at a predetermined rate.

The water within the buoyancy tank will submerge the platform 300 to a limited extent, at least to the degree that the plurality of bi-directional turbine devices 1 are submerged to the extent that they are not damaged by the waves slamming on the bi-directional turbine devices 1 due to increasing wave heights, e.g. during storm conditions.

When the storm secedes and wave height decrease, the water source of the sub compartments inlets is removed. The drainage outlets at the bottom of each the sub compartments of the buoyancy tanks would drain away the water within said tank, due to height difference between the water level in the buoyancy tank and the water level of the sea.

Another embodiment of the bi-directional turbine devices 1, wherein the electrical energy generators 100 are replaced with hydraulic pumps (not shown) for providing pressurized water for different applications, such as de-salination by reverse osmosis.

During repairs or maintenance or similar, an arrangement with a plurality of bi-directional turbine devices 1 installed on a platform 300, wherein the plurality of devices 1 are in operation, i.e. generating electricity, at least a turbine device 1 of the plurality of bi-directional turbine devices 1 can be uninstalled from the arrangement, e.g. for repairs or replacement, without the disrupting the operation of the remaining bi-directional turbine devices 1.

1. A bi-directional turbine device (1) for generating electrical energy from wave movements, the turbine device (1) being adapted to be arranged below the water line, characterized in that the bi-directional turbine device (1) includes:
a) a first shaft element (10) with a second end section (10b) being connected to a platform (300) for suspending the bi-directional turbine device (1),
b) a first hub unit (5) axially inserted on a first end section (10a) of the first shaft element (10),
c) a first flange (60) and a second flange (61) fixed to the first end section (10a) at a predetermined distance from each other for limiting axial movement of the first hub unit (5) along the first shaft element (10),
d) a first shell element (3) enclosing the first hub unit (5) and the flanges (60, 61) for axially moving the first hub unit (5) due to downward or upward water flow impacting the first shell element (3),
e) a first plurality of blades (4) encircling the first shell element (3) and inserted to the first hub unit (5) for providing torque to a first end section (10a) of the first shaft (10),
wherein a base (4a) of each blade of the first plurality of blades (4) is inserted through the first shell element (3) and into the first hub unit (5),
f) a pitch angle change assembly (40) connecting at least one of the flanges (60, 61) and the first plurality of blades (4),
wherein the pitch angle change assembly (40) provide predetermined pitch angles (a1, a2) of the first plurality of blades (4) from the axial movement of the first hub unit (5).

2. Bi-directional turbine device (1) according to claim 1, wherein the second end section (10b) of the first shaft element (10) is connected to a first electrical energy generator (100a) on the platform (300).

3. Bi-directional turbine device (1) according to claim 1, wherein the first end section (10a) of the first shaft element (10) includes a rod element (201) fixed to the first shaft element (10), wherein the rod element (201) is surrounded by a cylinder device (202) rotating about the rod element (201),
wherein the second end section (10b) of the first shaft element (10) is connected to a top part of a frame (300a) of the platform (300).

4. Bi-directional turbine device (1) according to claim 3, wherein the rod element (201) is a stationary part (201a) and the cylinder device (202) is a rotating part (202a),
wherein the stationary part (201a) and the rotating part (202a) together form a second electrical energy generator (100b).

5. Bi-directional turbine device (1) according to claim 1, wherein the bi-directional turbine device (1) further includes:
a) a second shaft element (10′) with a second end section (10b′) being connected to the platform (300) for holding the bi-directional turbine device (1),
b) a second hub unit (5′) axially inserted on a first end section (10a′) of the second shaft element (10′),
c) a first flange (60) and a second flange (61) fixed to the first end section (10a′) at a predetermined distance from each other for limiting axial movement of the second hub unit (5′) along the second shaft element (10′),
d) a second shell element (3′) enclosing the second hub unit (5′) and the flanges (60, 61) for axially moving the second hub unit (5′) due to downward or upward water flow impacting the first and second shell element (3, 3′),
wherein the second shell element (3′) is adjacent to the first shell element (3) at their widest opening and axially moves accordingly in the same axial direction with the first shell element (3),
e) a second plurality of blades (4′) encircling the second shell element (3′) and inserted to the second hub unit (5′) for providing torque to a first end section (10a′) of the second shaft (10′),
wherein a base (4a′) of each blade of the second plurality of blades (4′) are inserted through the second shell element (3′) and into the second hub unit (5′),
wherein the second plurality of blades (4′) are adjacently below the first plurality of blades (4),
f) a pitch angle change assembly (40) connecting at least one of the flanges (60, 61) and the second plurality of blades (4′),
wherein the pitch angle change assembly (40) provide predetermined pitch angles (a1, a2) of the second plurality of blades (4′) from the axial movement of the second hub unit (5),
wherein the pitch angle of the second plurality of blades (4′) is adapted to have a first pitch angle (a1) and the pitch angle of the first plurality of blades (4) is adapted to have a second pitch angle (a2),
wherein the pitch angle of the second plurality of blades (4′) is adapted to have second pitch angle (a2) and the pitch angle of the first plurality of blades (4) is adapted to have first pitch angle (a1).

6. Bi-directional turbine device (1) according to claim 5, wherein the second shaft (10′) is located within the first shaft element (10), the second shaft (10′) is connected to the first electrical energy generator (100a) on the platform (300) by a differential unit (80), wherein the differential unit (80) further transfers torque from the second shaft (10′) to the first electrical energy generator (100a).

7. Bi-directional turbine device (1) according to claim 5, wherein the second end section (10b) of the second shaft element (10′) is connected to a bottom part of a frame (300a) of the platform (300),
wherein a stationary part (201a) of the first shaft element (10) and a stationary part (201a) the second shaft element (10′) is a single connecting stationary part (2010),
wherein the single connecting stationary part (2010) is surrounded by two rotating parts (202a) rotating about the single connecting stationary part (2010),
wherein each of the two rotating parts (202a) rotating about the single connecting stationary part (2010) form a second electrical energy generator (100b).

8. Bi-directional turbine device (1) according to claim 1, wherein the pitch angle change assembly (40) is a first pitch angle change assembly (41), wherein each blade of the first plurality of blades (4) includes a protrusion (4b) at the base (4a) of each blade, wherein the protrusion (4b) is connected to a lever item (41a) and the lever item (41a) is connected to a protrusion (60a, 61a) of a plurality of protrusions of a flange (60, 61) circumferentially located on the flange (60, 61) facing the hub unit (5, 5′).

9. Bi-directional turbine device (1) according to claim 1, wherein the pitch angle change assembly (40) is a second pitch angle change assembly (42), wherein the base (4a) of each blade of the first plurality of blades includes a gear (4c) which interact with an elongated protrusion with linear gears (70), wherein the elongated protrusion extends from a flange (60, 61).

10. A bi-directional turbine device (1) for generating electrical energy from wave movements, the turbine device (1) being adapted to be arranged below the water line, characterized in that the bi-directional turbine device (1) includes:
a) a first shaft element (10) with a second end section (10b) being connected to a platform (300) for suspending the bi-directional turbine device (1),
b) a first hub unit (5) axially inserted on a first end section (10a) of the first shaft element (10),
wherein the first hub unit (5) includes a gear (5a) for engaging the first end section (10a),
c) a second hub unit (5′) axially inserted on a first end section (10a) of the first shaft element (10),
wherein the second hub unit (5′) includes a gear (5a′) for engaging the first end section (10a),
d) the first end section (10a) further includes a first gear (90) located at the extreme end of the first end section (10a) and a second gear (91) located at a predetermined distance of the extreme end of the first end section (10a),
wherein the first gear (90) engages with the gear (5a′) of the second hub unit (5′) and providing torque from the second hub unit (5′) on the first end section (10a) and forming the first gear set (900),
wherein the second gear (91) engages with the gear (5a) of the first hub unit (5) and providing torque from the first hub unit (5) on the first end section (10a) and forming the second gear set (910),
e) a first shell element (3) enclosing the first hub unit (5) for axially moving both the first hub unit (5) and the second hub unit (5′) and activating the second gear set (910) at downward water flow impacting the first shell element (3),
f) a second shell element (3′) enclosing the second hub unit (5) for axially moving both the first hub unit (5) and the second hub unit (5′) and activating the first gear set (900) at upward water flow impacting the second shell element (3),
wherein the second shell element (3′) is adjacent to the first shell element (3) at their widest opening and axially moves accordingly with the first shell element (3),
g) a first plurality of blades (4) encircling the first shell element (3) and inserted to the first hub unit (5) for providing torque to a first end section (10a) by the second gear set (910),
wherein a base (4a) of each blade of the first plurality of blades (4) are inserted through the first shell element (3) and into the first hub unit (5),
wherein each of the blades the first plurality of blades (4) have a fixed first pitch angle (a1),
h) a second plurality of blades (4′) encircling the second shell element (3′) and inserted to the second hub unit (5′) for providing torque to a first end section (10a) by the first gear set (900),
wherein a base (4a′) of each blade of the second plurality of blades (4′) are inserted through the second shell element (3′) and into the second hub unit (5′),
wherein each of blades of the second plurality of blades (4′) have a fixed second pitch angle (a2).

11. A bi-directional turbine device (1) according to claim 10, wherein the first end section (10a) includes a third electric energy generator (100c) comprising a second cylinder device (203),
wherein the second cylinder device (203) includes the first gear (90) and second gear (91) for engaging the gears (5a, 5a′) of the first and second hub units (5, 5′),
and a second rod (204) in connection with at least a shaft element (10, 10′),
wherein the second cylinder device (203) rotates about the second rod (204),
wherein the at least a shaft element (10, 10′) is connected to a frame (300a) of a platform (300).

12. A bi-directional turbine device (1) for generating electrical energy from wave movements, the turbine device (1) being adapted to be arranged below the water line, characterized in that the bi-directional turbine device (1) includes:
a) a first shaft element (10) with a second end section (10b) being connected to the platform (300) for suspending the bi-directional turbine device (1),
b) a first plurality of blades (4) encircling and is fixed to a first end section (10a) of the first shaft element (10) for providing torque to a first end section (10)
wherein the provided torque is in the clockwise or counter-clockwise direction,
wherein each of the blades the first plurality of blades (4) has a same pitch angle (a1, a2) that is fixed.

13. Bi-directional turbine device (1) according to claim 12, wherein the second end section (10b) of the first shaft element (10) is connected to a fourth electrical energy generator (100d) on the platform (300),
wherein the fourth electrical energy generator (100d) includes and receives torque from a third differential unit (81) in one fixed direction,
wherein the third differential unit (81) receives torque is in the in a clockwise or counter-clockwise direction from the second end section (10b) of the first shaft element (10),
wherein the third differential unit (81) provide the received torque from the first shaft element (10) to the fourth electrical energy generator (100d).

14. Bi-directional turbine device (1) according to claim 12, wherein a first shell element (3) is located between the first plurality of blades (4) and the first end section (10a).

15. Bi-directional turbine device (1) according to claim 12, wherein the first end section (10a) or the first shell element (3) includes an end part (3a),
wherein the end part (3a) is fixed to a support structure (not shown) of the platform (300),
wherein the first end section (10a) or the first shell element (3) is rotatable about the end part (3a),
wherein the first end section (10a) or the first shell element (3) is limited in movement in the vertical, longitudinal and transverse direction by the end part (3a).

16. Bi-directional turbine device (1) according to each of the claim 13, wherein the third differential unit (81) comprise of a first ring gear (811), a second ring gear (812), a first pinion (813), a second pinion (814) and a drive pinion (815),
wherein the first ring gear (811) is connected to a shaft of the fourth electrical energy generator (100) and the first ring gear (811) includes an inner edge gears (811a) and outer edge gears (811b),
wherein the second ring gear (812) includes an inner edge gears (812a) and outer edge gears (812b),
wherein the first pinion (813) and second pinion (814) are positioned between the first- and second ring gears (811, 812),
wherein the first pinion (813) and second pinion (814) are mated with the first- and second ring gears (811, 812),
wherein the drive pinion (815) positioned between the first- and second ring gears (811, 812) and is connected to the second end section (10b) of the first shaft element (10),
wherein the drive pinion (815) is intended to mate with the inner edge (811a, 812a) of the first- or second ring gear (811, 812).

17. Bi-directional turbine device (1) according to claim 1, wherein the bi-directional turbine device (1) further includes a funneling unit (2) encircling at least a shell element (3, 3′) and a plurality of blades (4, 4′) for receiving and converging a flow of water towards a plurality of blades (4, 4′) from an open end (2a, 2b) of the funneling unit (2).

18. Bi-directional turbine device (1) according to claim 1, wherein the device (1) further includes at least one support motor or a flywheel for providing a hub unit (5, 5′) torque for at least one rotation at the change of a predetermined pitch angle (a1, a2) of the first or second plurality of blades (4, 4′).

19. An arrangement for generating electrical energy comprising:
a floating platform (300), and a plurality of bi-directional turbine devices (1),
wherein each of the plurality of bi-directional turbine devices (1) are suspended from the platform (300) by a first shaft element (10) and the plurality of bi-directional turbine devices (1) are positioned at predetermined depth below the water line.

20. Arrangement according to claim 19, wherein the platform (300) further includes a plurality of first electrical energy generators (100a) on the platform (300), wherein each of the first electrical energy generators (100a) is suspending a bi-directional turbine device (1) below the waterline with a first shaft element (10) at a predetermined depth, wherein the bi-directional turbine device (1) drives the first electrical energy generators (100a) with the first shaft element (10).

21. Arrangement according to claim 19, wherein the platform (300) further includes a frame (300a) for suspending or holding at least a bi-directional turbine device (1),
wherein the at least one bi-directional turbine device (1) is connected to at least a top or a bottom (300a) by at least a shaft element (10, 10′) of the bi-directional turbine device (1).

22. Arrangement according to claim 19, wherein the platform (300) is moored to floor of a body water with taut mooring lines for keeping the platform at a predetermined depth.

23. Arrangement according claim 19, wherein the platform (300) further includes a one or more heave plates (301) near the bottom of the platform (300) for limiting heave and roll movements affecting the platform (300) deriving from the waves.

24. Arrangement according claim 19, wherein the platform (300) further includes at least a ballast tank and a buoyancy tank for providing self-regulating ballasting,
wherein the buoyancy tank includes at least two sub compartments (not shown) vertically positioned on top of each other,
wherein each of the sub compartments have at least an inlet (not shown) on top of the sub compartment and an outlet at the bottom (not shown) of the sub compartment,
wherein the outlet of a top sub compartment is in communication with the inlet of the bottom sub compartment.
